(19) United States
(12) Patent Application Publication
(10) Pub. No.: US 2025/0298751 A1
(43) Pub. Date: Sep. 25, 2025

(54) ENHANCED SUPPORT FOR VOLATILE AND NON-VOLATILE EXTERNAL MEMORY

(71) Applicant: TEXAS INSTRUMENTS INCORPORATED, Dallas, TX (US)

(72) Inventors: Mihir Mody, Bangalore (IN); Prithvi Shankar Yeyyadi Anantha, Bangalore (IN); Deepshikha Gusain, New Delhi (IN); Rohit Ranjan, Noida (IN)

(21) Appl. No.: 18/893,047

(22) Filed: Sep. 23, 2024

(30) Foreign Application Priority Data
Mar. 22, 2024 (IN) 202441022054

(51) Int. Cl. G06F 12/14

(52) U.S. Cl. CPC G06F 12/1441; G06F 12/1458

(57) ABSTRACT

In an example embodiment, a device includes an address protocol controller configured to receive an access request that includes an address associated with an external memory, and an external memory interface controller coupled to the address protocol controller and configured to couple to the external memory. The address protocol controller is configured to determine, based on a type of the external memory device, whether to generate a modified address associated with the address in the access request. Based on the external memory device being a first type, the address protocol controller is configured to provide the address to the external memory. Based on the external memory being a second type, the address protocol controller is configured to generate the modified address and provide the modified address to the external memory interface controller to access the external memory.

### CROSS-REFERENCE TO RELATED APPLICATIONS

This application claims the priority benefit of India Provisional Patent Application No. 202441022054, filed Mar. 22, 2024, entitled “OPTI-RAM: Method and System to support External RAM and Flash for MCU,” which is hereby incorporated by reference in its entirety.

### TECHNICAL FIELD

This relates generally to embedded processing systems, and in particular, to enhanced access to external memory devices.

### BACKGROUND

Embedded systems include processing cores to run software programs by reading program instructions from memory and executing them to perform various functions associated with the software. The processing cores generally execute software programs with greater speed and reduced latency from internal memory. However, the increasing complexity and size of software programs sometimes requires the processing cores to execute code from one or more external memory devices.

To execute code from external memory, processing cores interface with external memory devices via external memory interface controllers. For example, an embedded device may include a non-volatile interface controller to interface between the processing cores and an external memory device of a non-volatile type. Similarly, an embedded device may include a volatile memory interface controller to interface between the processing cores and external memory of a volatile type.

External memory interface controllers access the external memory devices based on device-specific protocols. For example, the protocol used to write data to non-volatile external memory may differ from that used to write data to volatile external memory. Some existing memory interface controllers are capable of communicating with both volatile and non-volatile external memory devices. However, such general-purpose memory interface controllers effectively implement two interface controllers in one, and as such have large design area requirements. For example, distinct circuitry is provided in the interface controllers for communicating with different types of external memory.

### SUMMARY

The technology described herein includes an address protocol controller that allows an external memory interface controller to interface with different types of external memory devices without requiring extraneous, duplicative, or additional circuitry. That is, the external memory interface controller may employ much of the same circuitry to communicate with one type of external memory as it does to communicate with a different type of external memory, thereby saving space and cost.

In an example embodiment, a device is provided that includes an address protocol controller and an external memory interface controller. The address protocol controller is configured to receive an access request that includes an address associated with an external memory device. The external memory interface controller is coupled to the address protocol controller and is configured to couple to the external memory device. The address protocol controller is configured to determine, based on a type of the external memory device, whether to generate a modified address associated with the address in the access request. Based on the external memory device being a first type, the address protocol controller is configured to provide the address to the external memory. Based on the external memory being a second type, the address protocol controller is configured to generate the modified address and provide the modified address to the external memory interface controller, which then accesses the external memory based on the modified address determined by the address protocol controller.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example system in an implementation.

FIG. 2 illustrates an address modification method in an implementation.

FIG. 3A illustrates an example block diagram in an implementation.

FIG. 3B illustrates an example operational scenario with respect to accessing non-volatile memory in an implementation.

FIG. 3C illustrates an example operational scenario with respect to accessing volatile memory in an implementation.

FIG. 3D illustrates example representations of signals for accessing external memory in an implementation.

FIG. 4A illustrates an example block diagram in an implementation.

FIG. 4B illustrates an example operational scenario with respect to reading from and writing to non-volatile memory in an implementation.

FIG. 4C illustrates an example operational scenario with respect to reading from volatile memory in an implementation.

FIG. 4D illustrates an example operational scenario with respect to writing to volatile memory in an implementation.

FIG. 5 illustrates an example block diagram in an implementation.

FIG. 6 illustrates an example block diagram in an implementation.

FIG. 7 illustrates an example block diagram in an implementation.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Technology is disclosed herein that mitigates the problems discussed above with respect to supporting different types of external memory. In various embodiments, an address protocol controller is disclosed that—depending upon the type of external memory that is installed—modifies the addresses in access requests to be compatible with the installed type of memory device. More specifically, the address protocol controller refrains from modifying the addresses when the external memory device is of a non-volatile type but modifies the addresses when the external memory device is of a volatile type. The address protocol controller forwards the addresses (modified or not) to an external memory interface controller that itself performs read or write operations with respect to the external memory.

In some embodiments, the external memory interface controller is natively capable of interfacing with non-volatile memory devices. The address modification functionality of the address protocol controller may be disabled in such cases involving non-volatile memory devices. However, when the external memory device is of the volatile memory type, the address protocol controller modifies the addresses in access requests (e.g., read requests, write requests) based on a volatile memory protocol so the external memory interface controller can access the external volatile memory. Advantageously, the disclosed system enables access to multiple types of external memory devices using the same physical circuitry, which reduces design area and saves costs.

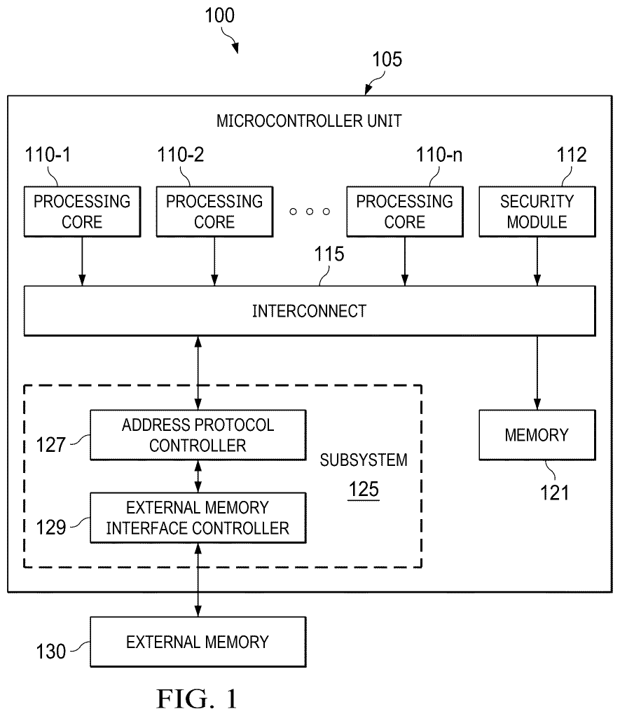

Turning now to the drawings, FIG. 1 illustrates system 100, which includes MCU 105 and external memory 130. MCU 105 includes processing cores 110-1 through 110-n (collectively processing cores 110), security module 112, interconnect 115, memory 121, and subsystem 125. Subsystem 125 includes address protocol controller 127 and external memory interface controller 129.

In various embodiments, system 100 is representative of a processing system that includes various hardware, software, and firmware elements. Some elements of system 100 may be onboard a chip (e.g., a system-on-chip (SoC), an integrated circuit (IC)), while some elements may be located off-chip relative to other elements. For example, external memory 130, among other external memory devices, peripheral devices, and the like, may be off-chip.

System 100 shows MCU 105, which includes processing cores 110 and memory 121 from which processing cores 110 read data and write data during operation. Processing cores 110 are representative of one or more processors, processing cores, or processing circuitry capable of executing software and firmware, such as program instructions (e.g., application code, loadable instructions, read-only data, execute-in-place XIP) code, and the like). Examples of such processor(s) may include microcontrollers, digital signal processors (DSPs), general purpose processing units, central processing units (CPUs), application specific processors or circuits (e.g., ASICs), and logic devices (e.g., FPGAs), as well as other types of processing devices, combinations, or variations thereof.

Security module 112 (which is optional) is representative of a processor, hardware accelerator, or other processing device configured to perform functional safety and security operations on data being read from memory 121 by one or more of processing cores 110. In various examples, security module 112 may identify a read request by processing cores 110, obtain data associated with the read request, and perform a functional safety and security operation on the data to verify that the data is not suspicious or malicious.

Memory 121 is representative of computer-readable storage media located on-chip. For example, memory 121 may be random access memory (RAM), tightly-coupled memory (TCM), or another type of memory. Processing cores 110 access memory 121 via interconnect 115 to read data from memory 121 or write data to memory 121. While shown as a single block in MCU 105, memory 121 may be implemented as multiple memory devices functioning in an integrated or separate manner.

Some program instructions executable by processing cores 110 may be initially stored in one or more external memory devices, such as external memory 130 (e.g., non-volatile memory or volatile memory) and copied to memory 121 for execution by processing cores 110, while some program instructions (e.g., execute-in-place code) stored on external memory 130 may configured to be executed directly out of memory without first being copied to memory 121. External memory 130 may be representative of off-chip volatile (e.g., RAM) or non-volatile memory. Examples of non-volatile memory include—but are not limited to—flash memory, non-volatile RAM (NVRAM), erasable programmable read-only memory (EPROM), and electrically erasable programmable ROM (EEPROM). In some embodiments, system 100 may include additional external memory devices each of the same or different type of memory.

In executing either set of program instructions, processing cores 110 request access to memory devices via access requests. Access requests refer to input-output (I/O) operations, such as read operations and write operations. To read or write from memory 121, processing cores 110 may directly access memory 121 via interconnect 115. To read or write from external memory 130, however, processing cores 110 may utilize subsystem 125 to interface with external memory 130.

Subsystem 125 is representative of an external memory interface control subsystem capable of operating in two modes to access both volatile memory and non-volatile memory. Subsystem 125 includes address protocol controller 127 and external memory interface controller 129.

In various embodiments, external memory interface controller 129 is representative of a memory interface controller capable of interfacing with external memory 130 based on access requests provided by processing cores 110. External memory interface controller 129 may be a non-volatile memory interface controller natively configured to read from and write to non-volatile memory devices. In particular, in some embodiments, external memory interface controller 129 supports various types of interfaces, including serial interfaces (e.g., OSPI, QSPI, xSPI, LP4) and/or parallel interfaces.

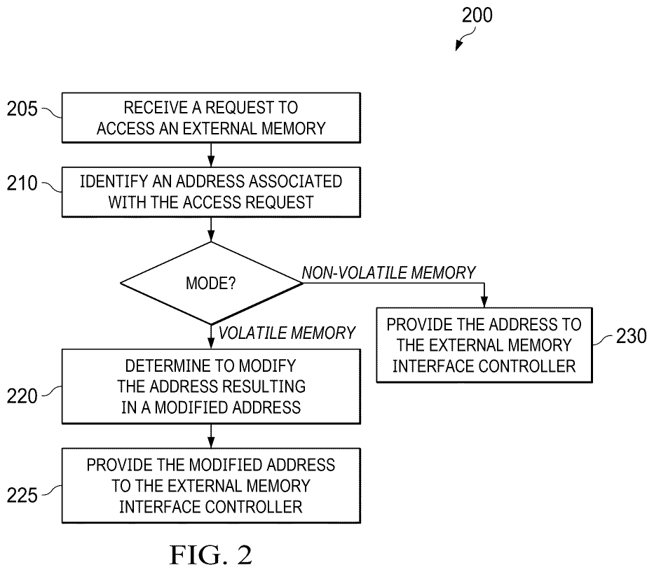

Address protocol controller 127 is included in subsystem 125 to modify addresses in the access requests so that external memory interface controller 129 can also interface with volatile memory devices based on the modified addresses. Address protocol controller 127 is representative of one or more processors or processing cores, hardware accelerators, circuits, or other processing devices capable of determining to modify addresses specified in the access requests in accordance with volatile memory protocols. Address protocol controller 127 may also be capable of performing functional safety and security operations, including encryption and decryption, with respect to requests corresponding to external memory 130. FIG. 2 illustrates an address modification method 200 employed by subsystem 125 to allow for access to external memory 130 regardless of memory type.

Referring now to FIG. 2, method 200 may be implemented in logic in the context of hardware elements of subsystem 125. Subsystem 125 operates as follows, referring parenthetically to the steps in FIG. 2.

At operation 205, address protocol controller 127 receives a request to access external memory 130. The request may indicate a write operation or a read operation as well as an address at which to access external memory 130. Accordingly, at operation 210, address protocol controller 127 identifies the address associated with the request.

Next, the process follows a volatile memory mode path or a non-volatile memory mode path based on the type of external memory 130. In various embodiments, address protocol controller 127 is enabled to operate in one of the modes based on an indication provided by processing cores 110. For example, in some embodiments, address protocol controller 127 may include a flag or register having a value indicative of whether the installed memory (external memory 130) is a volatile memory device or a non-volatile memory device. In some such embodiments, one of processing cores 110 updates the register at a boot sequence. In some embodiments, one of processing cores 110 provides an enable signal to address protocol controller 127 indicative of the type of external memory 130.

When in the volatile memory mode, at operation 220, address protocol controller 127 determines to modify the address specified in the request to produce a modified address. In some embodiments, modifying the address includes translating the address from a format specified in the request to a format in accordance with a volatile memory protocol (e.g., RAM protocol).

After modifying the address of the request, at operation 225, address protocol controller 127 provides the modified address to external memory interface controller 129. External memory interface controller 129 uses the modified address and outputs a command to external memory 130 to read data from external memory 130 or write data to external memory 130 (based on the access request). In the case of a write request, external memory interface controller 129 may provide an acknowledgement to processing cores 110 via interconnect 115. In the case of a read request, external memory interface controller 129 provides data to processing cores 110 via interconnect 115.

When in the non-volatile memory mode, at operation 230, address protocol controller 127 provides the address specified in the request to external memory interface controller 129. As such, based on external memory 130 being a non-volatile memory, address protocol controller 127 may bypass address modification operations. Particularly, translation circuitry within the address protocol controller 127 may still perform address modification operations but selection circuitry causes the unmodified address to be output to external memory interface controller 129 based on the indication of external memory 130 being a non-volatile memory. Then, external memory interface controller 129 accesses external memory 130 based on the address.

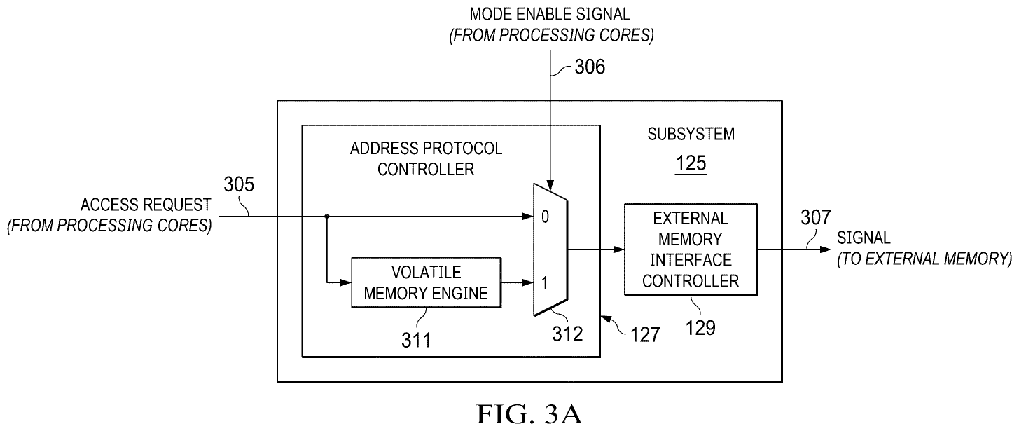

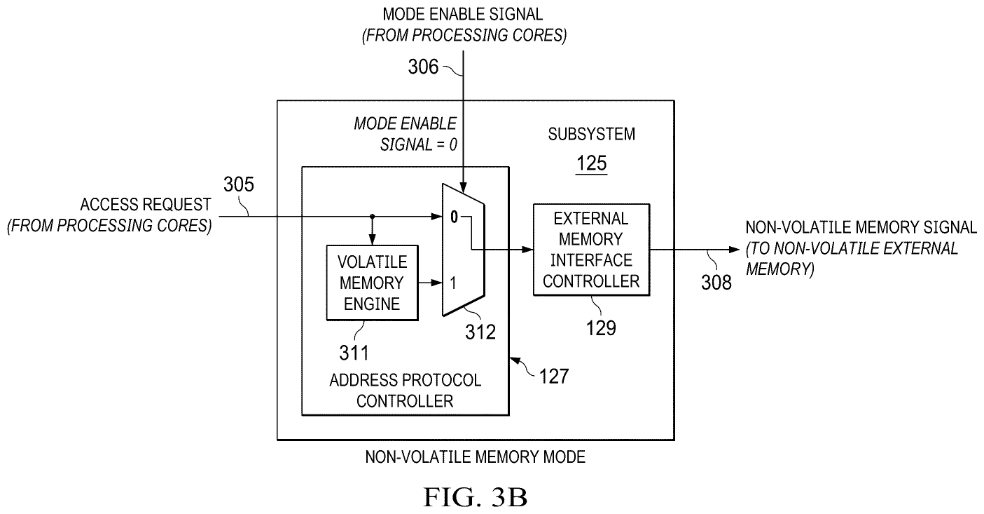

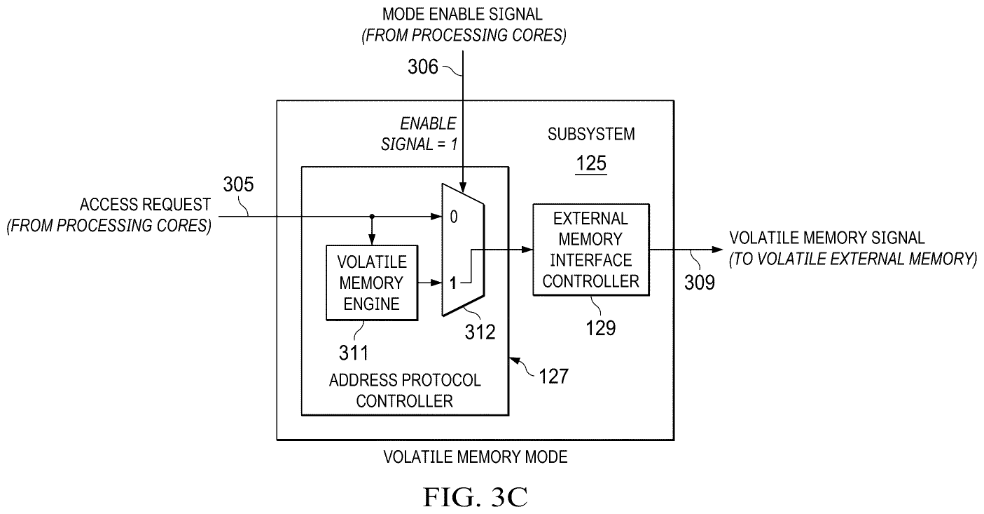

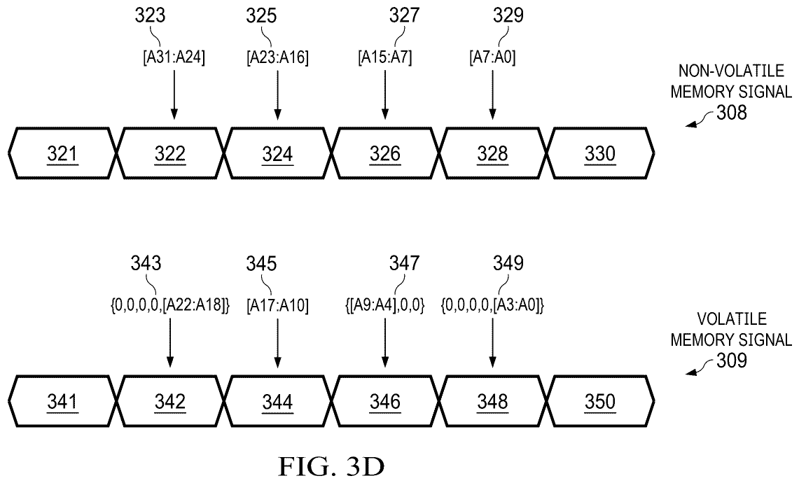

Example elements capable of implementing address modification processes are shown in FIGS. 3A, 3B, and 3C. In particular, FIG. 3A illustrates a block diagram, which is representative of a hardware architecture suitable for implementing subsystem 125. FIGS. 3B and 3C that follow the discussion of FIG. 3A illustrate operational scenarios involving elements of subsystem 125 where non-volatile memory and volatile memory are installed, respectively.

In FIG. 3A, address protocol controller 127 includes volatile memory engine 311 and multiplexer 312. Volatile memory engine 311 is representative of one or more components capable of modifying an address specified in access request 305. To modify an address, volatile memory engine 311 formats the address in accordance with a volatile memory protocol such that the modified address aligns with a format expected by external memory 130. For example, volatile memory engine 311 may align the address into a particular boundary or sequence of bytes (e.g., decrease the address to the nearest boundary address). Volatile memory engine 311 outputs the modified address to multiplexer 312.

Multiplexer 312 is representative of one or more components capable of receiving the original and modified addresses and selectively outputting one of the addresses based on mode enable signal 306. In the example illustrated by block diagram 301, based on mode enable signal 306 indicating a value of “0”, multiplexer 312 outputs the address of access request 305 without modification thereto. When mode enable signal 306 indicates a value of “1”, multiplexer 312 outputs the modified address. External memory interface controller 129 uses the address output by multiplexer 312 to access external memory 130 via signal 307.

FIG. 3B shows an operational scenario involving subsystem 125 that demonstrates an example implementation of elements of subsystem 125 when external memory interface controller 129 interfaces with a non-volatile memory device.

In FIG. 3B, address protocol controller 127 receives access request 305 indicating an address and an operation (e.g., read or write). Volatile memory engine 311 receives access request 305 and performs address modification operations on the address indicated in access request 305, and outputs a modified address to multiplexer 312. Multiplexer 312 receives the modified address as an input and also receives access request 305 as an input. In this example, multiplexer 312 receives mode enable signal 306 indicating a value of “0”, which corresponds to the external memory including non-volatile memory. As such, multiplexer 312 selects the address of access request 305 and outputs the address to external memory interface controller 129.

External memory interface controller 129 then uses the address output by multiplexer 312 (non-volatile memory signal 308) to access non-volatile memory. Non-volatile memory signal 308 may include a command, an address compatible with the non-volatile memory (i.e., in accordance with the non-volatile memory protocol), and data. Additional details regarding non-volatile memory signal 308 are illustrated in FIG. 3D and described below.

FIG. 3C shows an operational scenario that demonstrates an example implementation of elements of subsystem 125 when external memory interface controller 129 interfaces with a volatile memory device.

In FIG. 3C, address protocol controller 127 receives access request 305 indicating an address and an operation (e.g., read or write). Volatile memory engine 311 receives access request 305 and performs address modification operations on the address indicated in access request 305, and outputs a modified address to multiplexer 312. Multiplexer 312 receives the modified address as an input and also receives access request 305 as an input. In this example, multiplexer 312 receives mode enable signal 306 indicating a value of “1”, which corresponds to the external memory including volatile memory. As such, multiplexer 312 selects the modified address provided by volatile memory engine 311 and outputs the address to external memory interface controller 129.

External memory interface controller 129 then uses the address output by multiplexer 312 (volatile memory signal 309) to access volatile memory. Volatile memory signal 309 may include a command, an address compatible with the volatile memory and in accordance with the non-volatile memory protocol (e.g., reformatted into a byte alignment), and data. Additional details regarding volatile memory signal 309 are illustrated in FIG. 3D and described below.

FIG. 3D illustrates example elements of non-volatile memory signal 308 and volatile memory signal 309, which represent signals used to access external non-volatile memory and external volatile memory, respectively, based on the type of memory included in a system.

Non-volatile memory signal 308 and volatile memory signal 309 each include various sections in which information is contained. As shown in FIG. 3D, non-volatile memory signal 308 includes command section 321, address section 322, address section 324, address section 326, address section 328, and data section 330 (optional, e.g., included in write requests). Command section 321 may include indications corresponding to a type of access request (e.g., read, write) as well as other input/output (I/O) information. Address sections 322, 324, 326, and 328 each include blocks of addresses corresponding to one or more blocks of physical address spaces of the external non-volatile memory in accordance with a non-volatile memory protocol. For example, non-volatile memory signal 308 includes address 323 in address section 322, address 325 in address section 324, address 327 in address section 326, and address 329 in address section 328. Based on the non-volatile memory protocol, for a 32-bit address, each address includes an 8-bit address with which to access the non-volatile external memory.

External memory interface controller 129 generates the addresses and populates address sections based on an address set (e.g., logical addresses) included in the access request. Data section 330 includes data corresponding to the access request. In some examples, data section 330 might be empty in an outgoing read request but might be populated with data in an incoming signal from the external memory. In some examples, data section 330 includes data based on the access request including a write request.

Volatile memory signal 309 includes command section 341, address section 342, address section 344, address section 346, address section 348, and data section 350 (optional, e.g., included in write requests). Command section 341 similarly includes indications corresponding to a type of access request and I/O information, and data section 350 includes data corresponding to the access request. With respect to the address sections, when operating in volatile memory mode, address protocol controller 127 modifies an address set in the access request resulting in a modified address set (e.g., addresses 343, 345, 347, and 349) in accordance with a volatile memory protocol. The modification by address protocol controller 127 may entail translating the addresses of access request 305 from one format (e.g., a non-volatile memory format) to another format (e.g., a volatile memory format). In the illustrated example, address translation includes dividing the bits of the untranslated address among address sections 342-348 and appending predetermined values (e.g., zeros) to the bits in a given address section for alignment or other purposes. In that regard, volatile memory signal 309 may include address 343 in address section 342, address 345 in address section 344, address 347 in address section 346, and address 349 in address section 348, each address corresponding to one or more linear address spaces (e.g., byte addressable locations) as opposed to block addresses when communicating with non-volatile memory.

More particularly, addresses 343, 345, 347, and 349 may include a combination of bits among the bits in addresses 323, 325, 327, and 329 of non-volatile memory signal 308. For example, address 343 includes a subset of bits of address 325 as well as a number of zeros, address 345 includes a subset of bits of address 325 and a subset of bits of address 327, address 327 includes a subset of bits of address 327 and a subset of bits of address 329 as well as a number of zeros, and address 349 includes a subset of bits of address 329 as well as a number of zeros. The number of bits and the number of zeros in each address section of volatile memory signal 309 may be based on a type of volatile external memory, a configuration of the volatile external memory, and the like. Volatile memory engine 311 translates and/or re-formats an address into volatile memory signal 309 based on various parameters such that external memory interface controller 129 can access the volatile external memory using the modified address.

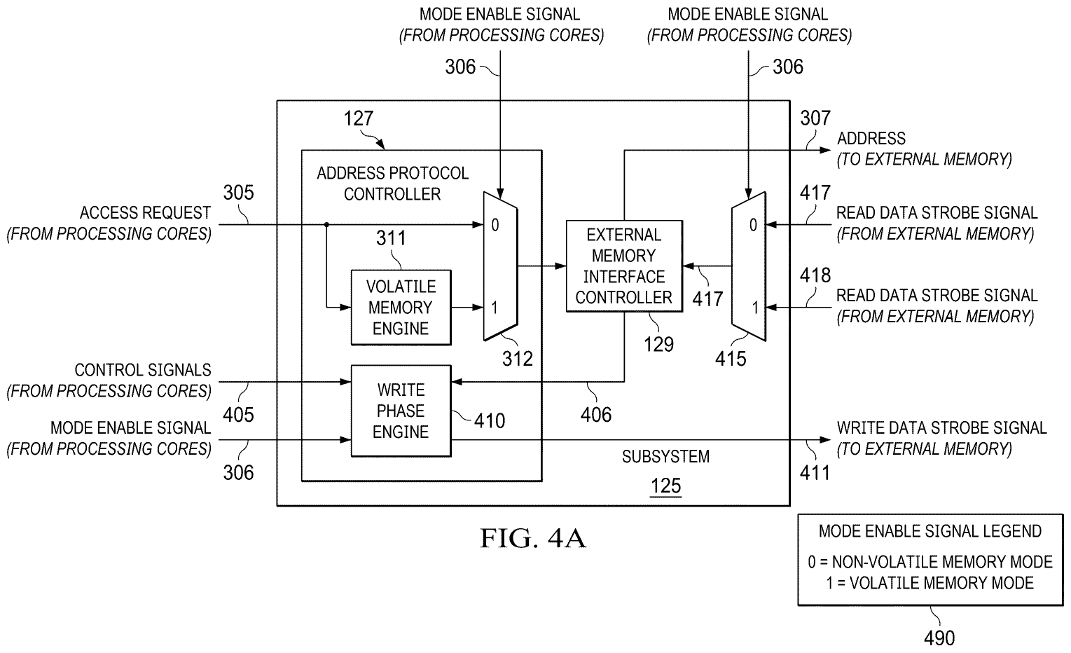

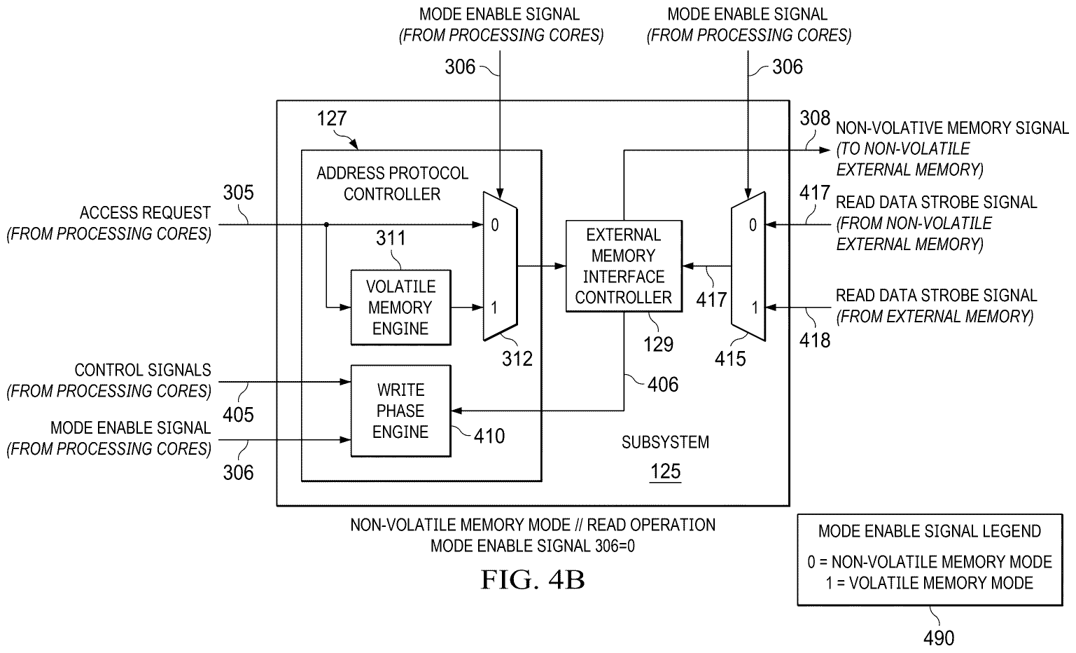

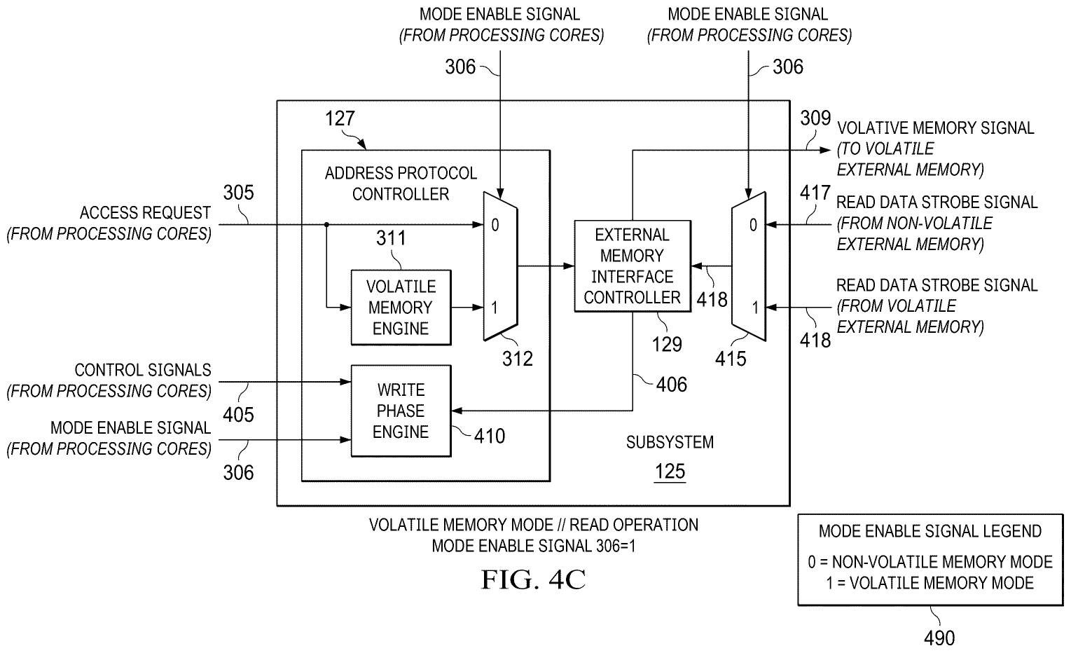

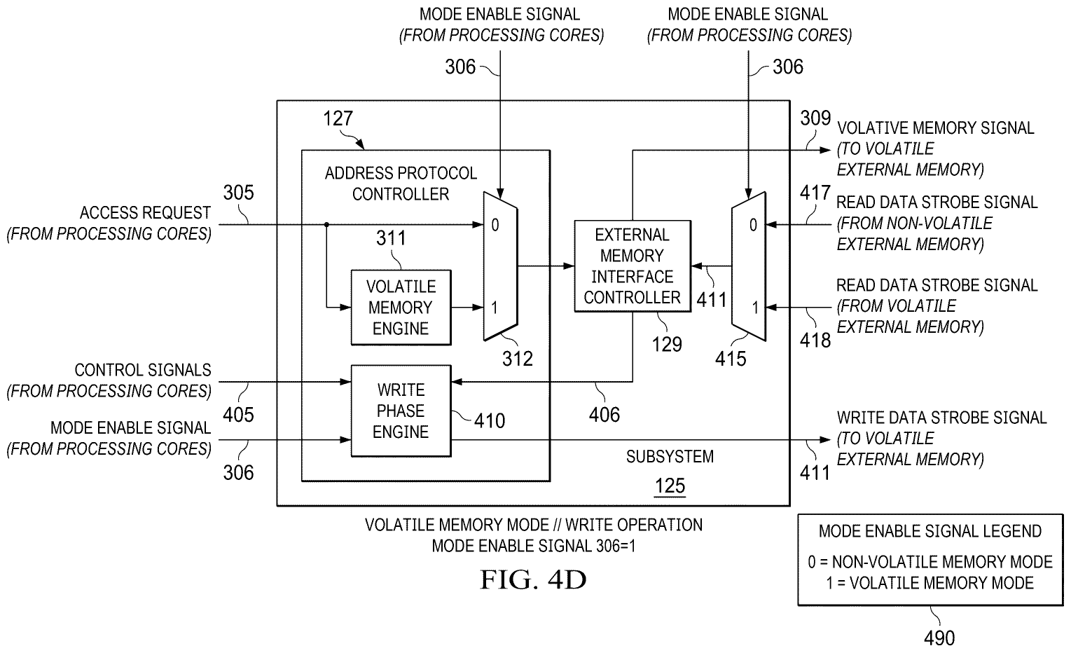

FIG. 4A illustrates an example block diagram, which shows subsystem 125 with components configurable to receive and output data strobe signals in addition to operations described above. FIGS. 4B, 4C, and 4D that follow the discussion of FIG. 4A illustrate operational scenarios involving elements of subsystem 125. In FIG. 4A, subsystem 125 includes external memory interface controller 129, multiplexer 415, and address protocol controller 127. Address protocol controller 127 includes volatile memory engine 311, multiplexer 312, and write phase engine 410.

External memory interface controller 129 interfaces with one or more external memory devices (e.g., external memory 130) to read from or write to the external memory devices. This may involve communicating input/output (I/O) commands, clock signals, and data strobe signals between external memory interface controller 129 and the external memory devices to ensure synchronization during read and write operations. The I/O commands may refer to read and write commands as well as data and addresses, while the data strobe signals may refer to signals accompanying I/O commands to indicate the timing and duration of data transfers between external memory interface controller 129 and the external memory devices. Multiplexer 415 is included in subsystem 125 to receive data strobe signals from external memory and selectively output a data strobe signal to external memory interface controller 129 based on mode enable signal 306.

When non-volatile memory is installed in a system, the external non-volatile memory device provides data strobe signals (e.g., read data strobe signal 417) to external memory interface controller 129 via multiplexer 415 during read operations and write operations. When volatile memory is installed in a system, the external volatile memory device may include a bidirectional data strobe pin with which it outputs data strobe signals (e.g., read data strobe signal 418) to external memory interface controller 129 via multiplexer 415 during read operations.

In accordance with volatile memory protocols, the external volatile memory device may expect to receive a data strobe signal as an input during write operations. However, external memory interface controller 129 might not have native capabilities to generate and output data strobe signals as such capabilities are not required to interface with non-volatile memories. To resolve this issue, subsystem 125 includes write phase engine 410 within address protocol controller 127.

Write phase engine 410 is representative of one or more components capable of determining a write phase for a given write operation and outputting a data strobe signal (e.g., write data strobe signal 411) to the volatile memory devices. Based on providing the data strobe signals to the volatile memory devices, external memory interface controller 129 can write data to the volatile memory devices at the proper time and for the appropriate duration in accordance with volatile memory protocols.

FIG. 4B shows an operational scenario involving subsystem 125 that demonstrates an example implementation when external memory interface controller 129 interfaces with a non-volatile memory device. In operation, volatile memory engine 311 and multiplexer 312 function as described above with respect to operational scenario 302 of FIG. 3B to output an address to external memory interface controller 129 based on non-volatile memory being installed. In this scenario, mode enable signal 306 indicates a value of “0”, and as such, external memory interface 129 outputs non-volatile memory signal 308. External memory interface 129 also receives read data strobe signal 417 from non-volatile external memory via multiplexer 415 (in accordance with legend 490). The non-volatile external memory device provides read data strobe signal 417 to subsystem 125 to synchronize read operations performed by external memory interface controller 129.

FIG. 4C shows an operational scenario involving subsystem 125 that demonstrates an example implementation when external memory interface controller 129 interfaces with a volatile memory device to perform a read operation. In operation, volatile memory engine 311 and multiplexer 312 function as described above with respect to operational scenario 303 of FIG. 3C to output a modified address to external memory interface controller 129 based on volatile memory being installed. In this scenario, mode enable signal 306 indicates a value of “1”, and as such, external memory interface 129 outputs volatile memory signal 309 and receives read data strobe signal 418 from volatile external memory via multiplexer 415 (in accordance with legend 490). The volatile external memory device provides read data strobe signal 418 to subsystem 125 to synchronize read operations performed by external memory interface controller 129.

FIG. 4D shows an operational scenario involving subsystem 125 that demonstrates an example implementation when external memory interface controller 129 interfaces with a volatile memory device to perform a write operation. In operation, volatile memory engine 311 and multiplexer 312 function as described above with respect to operational scenario 303 of FIG. 3C to output a modified address to external memory interface controller 129 based on volatile memory being installed. In this scenario, mode enable signal 306 indicates a value of “1”. Based on the mode enable signal, external memory interface 129 outputs volatile memory signal 309, while write phase engine 410 outputs write data strobe signal 411.

To generate write data strobe signal 411, write phase engine 410 receives control signals 405 from one or more processing cores (e.g., processing cores 110) and control signals 406 from external memory interface controller 129. Control signals 405 and 406 may include write enable signals, indications of predicted write phases, and parameters (e.g., duration) thereof. For example, control signals 405 and 406 indicate an upcoming write operation between external memory interface controller 129 and volatile external memory (e.g., external memory 130). Write phase engine 410 also receives mode enable signal 306 with which write phase engine 410 uses to determine whether to output write data strobe signal 411. Based on control signals 405 and 406 and mode enable signal 306, write phase engine 410 predicts timing and duration parameters associated with a write operation to generate write data strobe signal 411. Write phase engine 410 outputs write data strobe signal 411 to the volatile external memory. Based on the volatile external memory receiving write data strobe signal 411, external memory interface controller 129 writes data to the volatile external memory during the write phase in a synchronized manner.

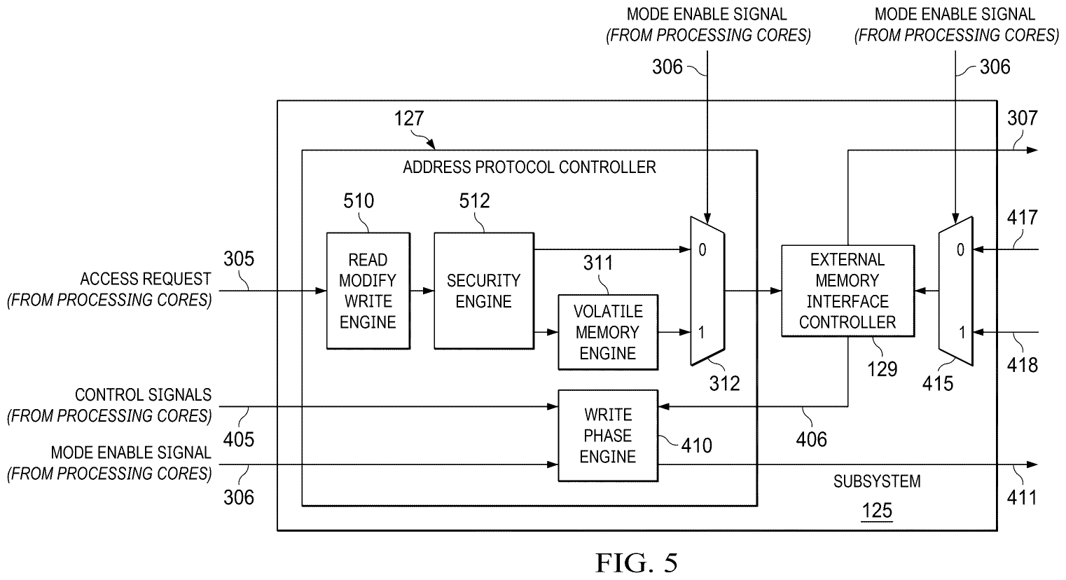

FIG. 5 illustrates an example block diagram, which shows subsystem 125 with components configurable to perform alignment and functional safety operations on access request 305 in addition to operations described above. In FIG. 5, subsystem 125 includes external memory interface controller 129, multiplexer 415, and address protocol controller 127, which includes read modify write (RMW) engine 510, security engine 512, write phase engine 410, and volatile memory engine 311.

RMW engine 510 is representative of one or more components configured to modify access requests with which to access external memory devices (e.g., external memory 130). In particular, RMW engine 510 may be used to split access request 305 into multiple transactions when the access request indicates a set of addresses where error correction code (ECC) data is stored.

By way of example, the external memory device coupled to external memory interface controller 129 may be arranged to store a number of bytes of ECC data (e.g., 4 bytes) for every n number of bytes of data (e.g., 32 bytes). For an access request attempting to access a range of addresses including (e.g., overlapping) the ECC data, RMW engine 510 is configured to split the access request into transactions such that the access request corresponds only to sections of the external memory including data but not ECC data.

As such, RMW engine 510 receives access request 305 from one or more processing cores (e.g., processing cores 110), generates an aligned access request (e.g., an access request including transactions within data boundaries), and outputs the aligned access request to security engine 512.

Security engine 512 is representative of one or more components configured to perform functional safety and security operations on access request 305. In particular, security engine 512 performs encryption on outgoing data to external memory, decryption on incoming data from external memory, and functional safety validation operations on the encryption and decryption performed on data.

Volatile memory engine 311 receives an aligned and encrypted access request from security engine 512 and performs as described above with respect to address translation to access the external memory such that external memory interface controller 129 can access the external memory based on access request 305.

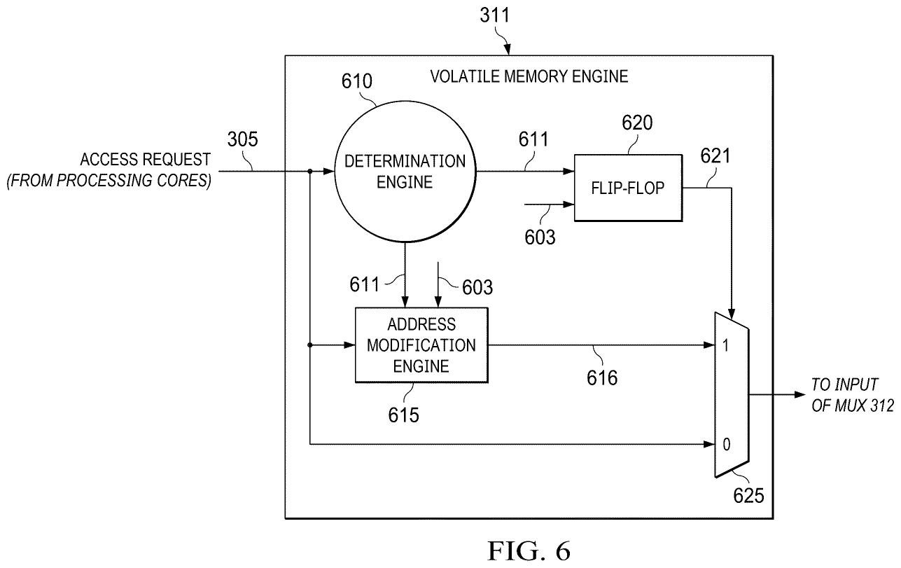

Example components capable of implementing address modification processes described in method 200 and shown in at least FIG. 3C are illustrated in FIG. 6. In particular, FIG. 6 illustrates a block diagram, which includes exemplary hardware elements of volatile memory engine 311 of address protocol controller 127. In FIG. 6, volatile memory engine 311 includes determination engine 610, address latching engine 615, flip-flop 620, multiplexer 625, address appending engine 630, and address translation engine 635, each of which may be representative of one or more hardware components capable of operating as follows.

Determination engine 610 receives access request 305 from a processing core (e.g., processing core 110-1). Access request 305 may be split into multiple transactions that are provided to volatile memory engine 311 sequentially. For example, the processing core may output an access request to write 32 bytes of data to external memory (e.g., external memory 130). Based on the bus capacity of the system, among other factors, the processing core may output the access request as multiple transactions each of a smaller size (e.g., four 8-bit block transactions for a 32 byte access request) relative to the access request. Each transaction may include an address and a set of data (for a write request).

Determination engine 610 identifies various indications in access request 305. The indications may include an indication of the access request, an indication of the first transaction of the access request, an indication of the last transaction of the access request, and an indication of readiness with respect to performing the access request (e.g., an indication output by an external memory interface controller (e.g., external memory interface controller 129) indicating a readiness to perform a read or a write operation). Based on the indications of access request 305, determination engine 610 generates enable signal 611. Determination engine 610 outputs enable signal 611 to address latching engine 615 and to flip-flop 620.

Enable signal 611 includes a logical value corresponding to the enablement of address modification operations (e.g., “1”) or a logical value corresponding to the disablement thereof (e.g., “0”). For example, determination engine 610 enables operations of address latching engine 615 (i.e., outputs enable signal 611 with a value of 1) based on the indication of the access request and based on the indication of the first transaction associated with the access request. Determination engine 610 disables operations of address latching engine 615 (i.e., outputs enable signal 611 with a value of 0) based on the indication of the last transaction associated with the access request and based on the indication of readiness.

Address latching engine 615 receives enable signal 611, clock signal 603, and access request 305. In particular, address latching engine 615 receives a transaction associated with access request 305, including a subset of the address associated with the transaction (e.g., a subset of the bits of the address). Based on being enabled by enable signal 611, address latching engine 615 latches the address and outputs latched address 616 to multiplexer 625. In various examples, to produce latched address 616, address latching engine 615 shifts the address of the transaction from one format to another format and stores the shifted address at a time based on clock signal 603.

Flip-flop 620 includes one or more flip-flop devices, latch devices, and/or other logic devices capable of storing state values of an input and providing an output including a state value. Flip-flop 620 receives clock signal 603 and enable signal 611 and stores a value corresponding to enable signal 611 based on clock signal 603. Further, flip-flop 620 outputs mode enable signal 621 to multiplexer 625. Mode enable signal 621 includes a value based on enable signal 611. For example, mode enable signal 621 includes a value of 1 based on an indication of enable signal 611 that address translation is required (e.g., “1”). Mode enable signal 621 may alternatively include a value of 0 based on an indication of enable signal 611 that address translation may be bypassed (e.g., “0”).

Multiplexer 625 receives the subset of the address (unlatched) associated with the transaction of access request 305 in addition to latched address 616 and mode enable signal 621. Based on mode enable signal 621, multiplexer 625 selectively outputs either latched address 616 or the unlatched address to address appending engine 630.

Address appending engine 630 receives an address from multiplexer 625 and a different address subset (e.g., the last address bit) associated with the transaction of access request 305. Address appending engine 630 adds the address subset to the address received from multiplexer 625 and outputs full address 631 to address translation engine 635. Address translation engine 635 then translates full address 631 to a format in accordance with a volatile memory protocol to generate translated address 636. To do so, address translation engine 635 may re-organize and/or re-format full address 631. Address translation engine 635 outputs translated address 636 to multiplexer 312.

By way of example, for an access request 305 including four transactions, determination engine 610 identifies an indication of access request 305 and identifies an indication of the first transaction of access request 305. Based on the indications, determination engine 610 outputs enable signal 611 including a value of 1 to enable latching operations. Address latching engine 615 receives enable signal 611 and turns on. Address latching engine 615 also receives a subset of the address of the first transaction (e.g., address bits [22:4]). In an example, the address of the first transaction includes a value of 0x0000, and the subset of the address includes a value of 0x000. Address latching engine 615 latches the subset of the address to produce latched address 616 (e.g., address bits [22:4] shifted to address bits [18:0]) and outputs latched address 616 to multiplexer 625.

Multiplexer 625 receives mode enable signal 621 from flip-flop 620 which includes a value of 1 based on enable signal 611. As such, multiplexer 625 selectively outputs latched address 616 to address appending engine 630. Address appending engine 630 receives another subset of the address of the first transaction (e.g., address bits [4:0]). Following the example above where the address of the first transaction is 0x0000, this subset received by address appending engine 630 may include a value of 0 (the last bit of the address). Address appending engine 630 appends this subset to latched address 616 to produce full address 631 including a value of 0x0000, which is next translated by address translation engine 635.

For the second transaction of access request 305, determination engine 610 may continue to output enable signal 611 having a value of 1 to enable address latching engine 615. Address latching engine 615 again latches the first subset of address bits of the address of the second transaction (e.g., 0x000) and provides latched address 616 to multiplexer 625. Multiplexer 625 outputs latched address 616 to address appending engine 630 based on mode enable signal 621. For this second transaction, address appending engine 630 receives a different value for the last bit of the address based on the processing core incrementing the address for the second transaction. For example, address appending engine 630 receives a value of 4 associated with this subset of the address of the second transaction. As such, address appending engine 630 appends this value to latched address 616 to produce full address 631 including a value of 0x0004, which is next translated by address translation engine 635.

The above operations are repeated by volatile memory engine 311 until determination engine 610 identifies an indication of the last (e.g., fourth) transaction associated with access request 305. Thus, for each of the transactions, a portion of the address of a respective transaction of access request 305 may be latched while a second, changing portion of the address (e.g., the last bit) may be appended to the latched portion of the address to provide a sequential address for translation and for use by the external memory interface controller. Advantageously, for an access request split into multiple transactions, determination engine 610 can enable address latching engine 615 to perform latching operations to latch the first address of the first transaction to ensure subsequent addresses for corresponding transactions are sequential and consistent, and thus, allowing for access to various types of external memory without altering logic of the external memory interface controller coupled to the external memory.

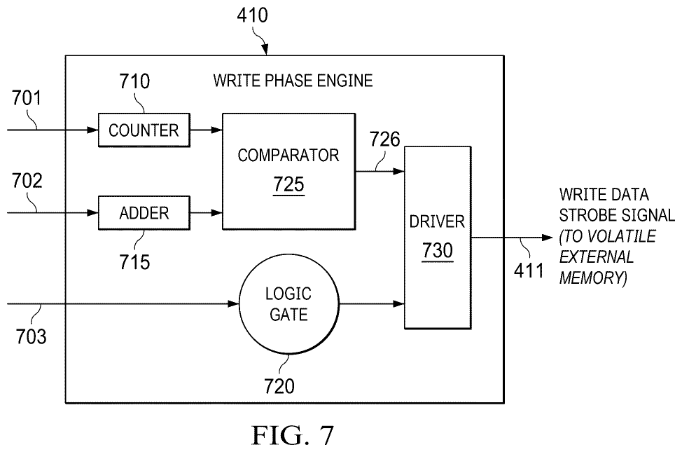

Example elements capable of implementing write phase prediction and data strobe signal generation processes as described in FIGS. 4A-4D are shown in FIG. 7. FIG. 7 shows a block diagram, which includes write phase engine 410 and components thereof. In particular, write phase engine 410 includes various hardware components, such as circuit devices, logic devices, and the like, configured to perform write phase prediction operations. In this example, write phase engine 410 includes counter 710, adder 715, comparator 725, logic gate 720, and driver 730.

In various examples, counter 710 is representative of a counter device coupled to receive toggle signal 701 (e.g., a chip select signal driven from the external memory interface controller, e.g., external memory interface controller 129) (e.g., control signals 406), initiate a counter value when toggle signal 701 toggles on, increment or decrement the counter value stored in counter 710, and provide an output signal to comparator 725. Adder 715 is representative of an adder device coupled to receive indications 702 (e.g., control signals 405 and/or 502) of clock cycles, including indications related to a number of dummy clock cycles, a number of clock cycles in a command phase, and a number of clock cycles in an address phase. Adder 715 adds values of each input and provides an output, including a number of clock cycles based on the inputs, to comparator 725. Comparator 725 receives inputs from counter 710 and adder 715, identifies matches and non-matches between the values of the inputs, and provides output 726 to driver 730. In some examples, comparator 725 provides output 726 that indicates a “match” when the counter value indicated in the output signal provided by counter 710 equals the sum of the clock cycles provided by adder 715.

Logic gate 720 may be representative of a bitwise AND gate coupled to receive inputs 703. Inputs 703 may be representative of enable signals output by an external memory interface controller (e.g., 8 total inputs corresponding to data lines of the Octal RAM) (e.g., control signals 406). Based on the values of inputs 703, logic gate 720 provides output 721 to driver 730.

Driver 730 may be representative of a device, circuit, or processor coupled to receive outputs 721 and 726, determine write and read phases based on outputs 721 and 726, and provide data strobe signal 716 to a volatile memory (e.g., volatile memory 530). More specifically, when output 726 indicates a match, driver 730 may identify values of output 721. Based on identifying that output 721 indicates a value of one, driver 730 may determine an occurrence of a read phase (i.e., a read phase may be about to begin) between an external memory interface controller and the volatile memory. Based on identifying that output 721 indicates a value of zero, driver 730 may determine an occurrence of a write phase (i.e., a write phase may be about to begin) between the external memory interface controller and the volatile memory. In response to determining the occurrence of the write phase, driver 730 may be configured to output write data strobe signal 411 to the volatile memory.

While some examples provided herein are described in the context of a system-on-chip, processor, microcontroller unit, circuitry, environment, or the like, the memory access methods, techniques, and systems described herein are not limited to such examples and may apply to a variety of other processes, systems, applications, devices, and the like. Aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some examples,” “according to some examples,” “in the examples shown,” “in other examples,” and the like generally mean the particular feature, structure, or characteristic following the phrase is included in at least one implementation of the present technology, and may be included in more than one implementation. In addition, such phrases do not necessarily refer to the same example or different examples.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A device, comprising:
an address protocol controller configured to receive an access request that includes an address associated with an external memory device; and
an external memory interface controller coupled to the address protocol controller and configured to couple to the external memory device;
wherein the address protocol controller is configured to:
determine, based on a type of the external memory device, whether to generate a modified address associated with the address in the access request;
based on the external memory device being a first type, provide the address to the external memory device; and
based on the external memory device being a second type:
generate the modified address; and
provide the modified address to the external memory interface controller; and
wherein the external memory interface controller is configured to access the external memory device based on the modified address determined by the address protocol controller.

2. The device of claim 1, wherein to generate the modified address, the address protocol controller is configured to convert a value of the address from a first value compatible with the first type of external memory to a second value compatible with the second type of external memory.

3. The device of claim 2, wherein to generate the modified address, the address protocol controller is configured to convert a format of the address from a first format compatible with the first type of external memory to a second format compatible with the second type of external memory.

4. The device of claim 2, wherein the address protocol controller is further configured to generate a data strobe signal to synchronize the external memory interface controller with the external memory device.

5. The device of claim 2, wherein the first type of external memory comprises non-volatile memory, and wherein the second type of external memory comprises volatile memory.

6. The device of claim 5, wherein the non-volatile memory comprises flash memory, and wherein the volatile memory comprises random access memory (RAM).

7. The device of claim 1, wherein to determine to generate the modified address, the address protocol controller is configured to read a mode enable flag that indicates the type of the external memory device.

8. A system, comprising:
one or more processing cores;
an interconnect coupled to the one or more processing cores;
an address protocol controller coupled to the interconnect and configured to receive, via the interconnect, an access request that includes an address associated with an external memory device; and
an external memory interface controller coupled to the address protocol controller and configured to couple to the external memory device;
wherein the address protocol controller is configured to:
determine, based on a type of the external memory device, whether to generate a modified address associated with the address in the access request; and
selectably provide the address or the modified address to the external memory interface controller; and
wherein the external memory interface controller is configured to access the external memory device based on the modified address determined by the address protocol controller.

9. The system of claim 8, wherein to generate the modified address, the address protocol controller is configured to convert a value of the address from a first value compatible with a first type of external memory to a second value compatible with a second type of external memory.

10. The system of claim 9, wherein to generate the modified address, the address protocol controller is configured to convert a format of the address from a first format compatible with the first type of external memory to t second format compatible with the second type of external memory.

11. The system of claim 10, wherein the address protocol controller is further configured to generate a data strobe signal to synchronize the external memory interface controller with the external memory device.

12. The system of claim 10, wherein the first type of external memory comprises non-volatile memory, and wherein the second type of external memory comprises volatile memory.

13. The system of claim 12, wherein the non-volatile memory comprises flash memory, and wherein the volatile memory comprises random access memory (RAM).

14. The system of claim 8, wherein to determine to generate the modified address, the address protocol controller is configured to read a mode enable flag that indicates the type of the external memory device.

15. A method, comprising:
receiving, from one or more processing cores, an access request that includes an address associated with an external memory device;
determining, based on a type of the external memory device, to generate a modified address associated with the address in the access request; and
accessing the external memory device based on the modified address.

16. The method of claim 15, wherein generating the modified address comprises converting a value of the address from a first value compatible with a first type of external memory to a second value compatible with a second type of external memory.

17. The method of claim 16, wherein generating the modified address comprises converting a format of the address from a first format compatible with the first type of external memory to the second format compatible with a second type of external memory.

18. The method of claim 16, further comprising generating a data strobe signal to synchronize access to the external memory device based on the access request including a write request.

19. The method of claim 16, wherein the first type of external memory comprises non-volatile memory, and wherein the second type of external memory comprises volatile memory.

20. The method of claim 15, wherein determining to generate the modified address comprises reading a mode enable flag that indicates the type of the external memory device.
